(19) United States
(12) Patent Application Publication
(10) Pub. No.: US 2010/0011911 A1
(43) Pub. Date: Jan. 21, 2010

(54) METHOD FOR MANUFACTURING A CUTTING BLADE, A CUTTING BLADE AND USE OF AN AUXILIARY MATERIAL IN MANUFACTURING THEREOF

(75) Inventors: Kari Aalto, Lempaala (FI); Veli-Pekka Immonen, Hameenlinna (FI)

Correspondence Address: VENABLE LLP, P.O. BOX 34385, WASHINGTON, DC, 20043-9998, US

(73) Assignee: LASER LANE OY, Hameenlinna (FI)

(21) Appl. No.: 12/440,555

(22) PCT Filed: Jul. 11, 2007
(86) PCT No.: PCT/FI2007/000189

§ 371 Date: Mar. 9, 2009

(30) Foreign Application Priority Data
Sep. 8, 2006 (FI) 20060803

(51) Int. Cl. B23P 15/40; B26D 1/14

(52) U.S. Cl. 76/115; 83/673

(57) ABSTRACT

A method for manufacturing a cutting blade, which cutting blade is meant particularly to be used as a rotating cutter blade and, which is manufactured from a blade preform, being provided with a cutting surface. The blade preform includes a frame part, being made of a basic material and in which on an attachment surface, existing essentially at a cutting area of the cutting blade to be manufactured, is processed at least a wear resistant material layer that forms the cutting surface. The layer includes steel that is alloyed with tungsten or chromium and vanadium. A cutting blade, being manufactured according to the method, and use of an auxiliary material in manufacturing thereof.

Method for manufacturing a disc blade, a disc blade and use of an auxiliary material in manufacturing thereof

The invention relates to a method for manufacturing a disc blade, a disc blade and use of an auxiliary material in manufacturing thereof. The disc blade is meant to be used particularly as a rotating cutter blade and it is manufactured from a blade preform, being provided with a cutting surface.

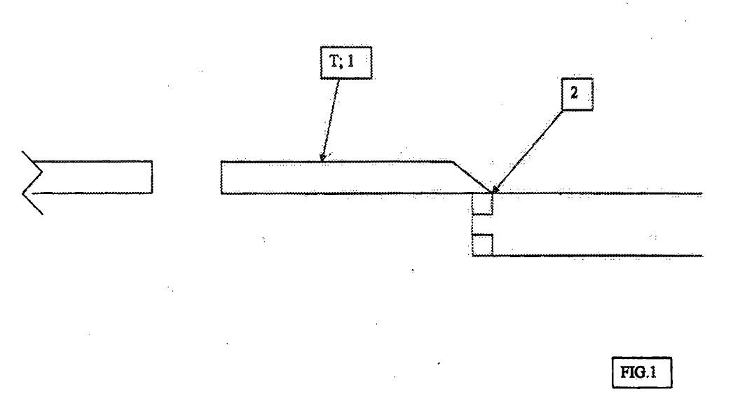

For example in connection with paper machines, there are being used blade devices for cutting of customer rolls, whereby paper is being cut between an upper blade and lower blade, which is strengthened by a hard metal tip, on the principle shown in FIG. 1. In this kind of a slitter, there are typically approximately 10 pairs of blades, in which the diameter of the cutting upper blade is e.g. 190 mm. From the point of view of the quality of the paper to be manufactured, it is most important to control the dust, being generating in connection with cutting, and to minimize the amount of dust that is left inside the customer rolls. This kind of dust is generated along with the blades becoming blunt.

Blade materials that are being used nowadays are traditionally used AISI D2-tool steel and as a newer alternative, Ralloy® WR6-upper blade material, being developed by Metso Powdermet, which is manufactured by applying powder metallurgy by means: of Hot Isostatic Pressing (HIP).

By virtue of the latter of the above blade materials, it has been managed to increase significantly the exchange interval of the blades, when compared to the tool steel, being used before. The sharpening of the blades, being manufactured from the material above, may be performed typically approximately 10-15 times, whereafter the diameter of the blade does not any more enable further sharpening. When using blades, being manufactured from tool steel, the exchange interval of the blades is typically 2-11 days, depending on the paper quality and the grinding method of the blade. By the above new material, it is possible to achieve an exchange interval of 15-40 days, thanks to which the maintenance costs of the blades have decreased significantly.

A problem of the Ralloy® WR6-material is nowadays the complicity of its manufacturing technique and the expensiveness of the blades, being manufactured therefrom. An other problem related to the material in question, is in practice also the fact that a blade being manufactured therefrom is very vulnerable to vibration, which arises from the hardness of the material in question. This problem has not occurred before in connection with tougher tool steel.

It is the aim of the method, disc blade and use of an auxiliary material in manufacturing thereof according to the invention at hand, to achieve a decisive improvement in the problems described above and thus to raise essentially the level of prior art. In order to carry out this aim, the method, disc blade and use of an auxiliary material in manufacturing thereof according to the invention are primary characterized by what has been stated in the characterizing parts of the independent claims related thereto.

When discussing the advantages of the invention, it should be mentioned first of all that the cutting surface, being achieved by the method according to the invention, is significantly better by its wear resistance than the same of the blades, being manufactured by nowadays techniques, which means more advantageous blades, longer exchange intervals and better paper quality in the paper manufacturing process, which is due to the better controlling than before of the dust problem. The manufacturing method according to the invention is significantly more advantageous than the manufacturing of blades by applying powder metallurgy. The manufacturing costs of the disc blade according to the invention, are essentially more advantageous than the same of present blades, being made by applying powder metallurgy, because it is possible to use the wear resistant, more expensive material only at the cutting surface of the blade that gets worn. In addition to that, the control of the vibration of the blades, being manufactured according to the invention, does not bring about a problem, which is due to the fact that in the frame part of the disc blade there can be used e.g. customary tool steel.

Advantageous embodiments of the method and the disc blade have been represented in the dependent claims related to the same.

In the following description, the invention is illustrated in greater detail with reference to the appended drawings, in which

in FIG. 1

is shown a typical use of a disc blade according to the invention, and

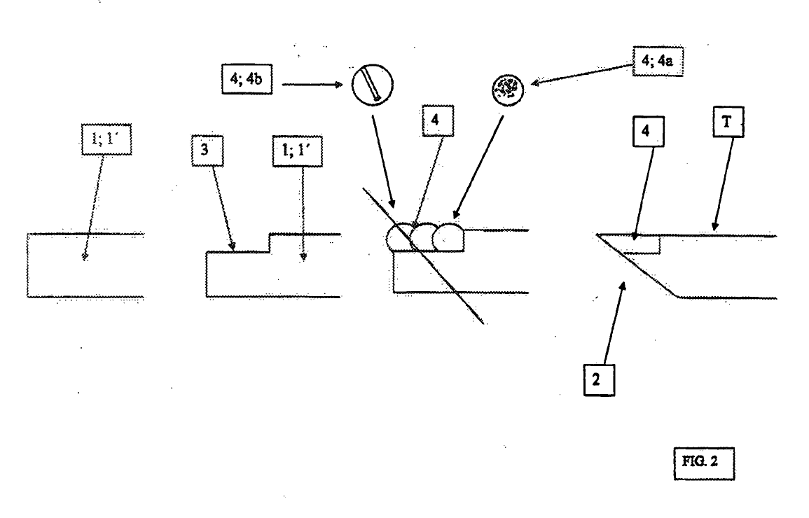

in FIG. 2

is shown an advantageous embodiment of the method and the disc blade according to the invention.

The invention relates to a method for manufacturing a disc blade, which disc blade T is meant particularly to be used as a rotating cutter blade, and, which is manufactured from a blade preform 1, being provided with a cutting surface 2. The blade preform 1 comprises a frame part 1′, being made of a basic material and in which on an attachment surface 3, existing essentially at a cutting area of the disc blade to be manufactured, is processed at least a wear resistant material layer 4 that forms the cutting surface 2, the layer consisting of steel (C_{min.}=2.5%) that is alloyed with tungsten/chromium (W_{min.}/Crₘᵢₙ=4%) and vanadium (V_{min.}=10%).

The method according to the invention is applicable particularly in manufacturing of a slitter blade T of a paper machine, which is shown on a principle level in FIG. 1. As an advantageous embodiment, in the manufacturing tool steel, being made by applying powder metallurgy, is exploited, such as Ralloy® WR6-steel or the like. The material layer 4 is being processed from ah auxiliary material 4a in powder state by applying powder metallurgy, such as Rapid Prototyping method (RP) or like, whereafter the material layer, when required, is being worked, machined and/or ground to accomplish the cutting surface 2 e.g. according to the third view in FIG. 2.

As an alternative implementation, the method according to the invention may be carried out in this context so that the material layer 4 is being processed from a wire 4b, existing in solid state, whereafter it is, when required, being worked, machined and/or ground to accomplish the cutting surface 2.

The latter alternative may be carried out as an advantageous embodiment further in a way that the auxiliary material wire 4b is being processed onto the attachment surface 3 by means of an electric arc or by utilising laser technique. In this connection, it is furthermore possible to use iron baked material as the auxiliary material wire 4b, which comprises as least the following substances: V: 16%, W: 6.0%, C: 3.9%, Sis 1.4% and MO: 0.4%. At the moment this kind of material is within reach e.g. with a brand name: Poly Van-0.

The frame part 1; 1′ of the blade preform is manufactured advantageously e.g. from customary tool steel, such as AISI D2 or the like.

The invention relates also to a disc blade being meant for the above purpose, which comprises a frame part 1′, being made of a basic material and having at its outer periphery an attachment surface 3, onto which there has been processed at least a wear resistant material layer 4, forming the actual cutting surface 2 and consisting of steel (C_{min.}=2.5%) that is alloyed with tungsten/chromium (W_{min.}/Cr_{min.}=4%) and vanadium (V_{min.}=10%).

The material layer 4 in the disc blade according to the invention comprises as an advantageous embodiment e.g. tool steel, such as Ralloy® WR6-steel or the like, being manufactured by applying powder metallurgy, or steel, being processed from an auxiliary wire 4b, existing in solid state, as shown on a principle level in the third view in FIG. 2.

As an advantageous embodiment the auxiliary material layer 4 consists of iron based material, comprising at least the following substances: V: 16%, W: 6.0%, C: 3.9%, Si: 1.4% and MO: 0.4%. Correspondingly the frame part 1; 1′ advantageously consists of customary tool steel, such as AISI D2 or the like.

The invention relates further to the use of a wear resistant auxiliary material 4, consisting of steel (C_{min.}=2.5%) that is alloyed at least with tungsten/chromium (W_{min.}/Cr_{min.}=4%) and vanadium (V_{min.}=10%) as a cutting surface 2 of a disc blade T to be used particularly as a rotating cutter blade, such as a slitter blade in a paper machine, the cutting surface being processed from the auxiliary material in powder shaped or wire-shaped state on an attachment surface 3, existing at the outer periphery of a frame part 1; 1′ of the disc blade, the frame part being made of a basic material. In this way it is possible to efficiently minimize the manufacturing costs of a disc blade by making only the cutting surface of the disc blade from a wear resistant, more expensive manufacturing material.

It is clear that the invention is not limited to the embodiment shown or described above, but it can be modified within the basic idea of the invention according to the uses and applications at any given time. Furthermore, the disc blades according to the invention may be applied e.g. to be used also as cutter blades to be used as so called single products. Furthermore, it is possible to form the attachment surface in the frame part angled or arched or the like deviating, from the right-angled shape as shown in FIG. 2.

1-6. (canceled)

7. A method for manufacturing a cutting blade comprising a rotating disc blade, the method comprising:
manufacturing the cutting blade from a blade preform, the blade preform comprising a frame part being made of a less expensive basic material;
providing the blade preform with a cutting surface,
processing on an attachment surface of the blade preform from at least a wear resistant material layer, the attachment surface being arranged essentially at a cutting area of the cutting blade to be manufactured, the wear resistant material layer comprising steel that is alloyed with tungsten or chromium and vanadium; and
making the wear resistant material layer from an auxiliary material wire, existing in solid state and being processed on to the attachment surface utilizing an electric arc or by utilizing, laser technique.

8. The method according to claim 7, wherein the processed material layer is being worked, machined and/or ground to accomplish the cutting surface.

9. The method according to claim 7, wherein as the auxiliary material wire an iron based material is being used, which comprises as least the following substances: V: 16%, W: 6.0%, C: 3.9%, Si: 1.4% and MO: 0.4%.

10. A cutting blade manufactured from a blade preform, the cutting blade comprising:
a cutting surface, the blade preform comprising a frame part, being made of a less expensive basic material and having at its outer periphery an attachment surface, onto which there has been processed at least a wear resistant material layer, forming the actual cutting surface and consisting of steel that is alloyed with tungsten or chromium and vanadium, wherein the cutting blade comprises a rotating disc blade.

11. The cutting blade according to claim 10, wherein the cutting blade comprises a slitter blade in a paper machine.

12. The cutting blade according to claim 10, wherein the material layer comprises iron based material, comprising at least the following substances: V: 16%, W: 6.0%, C: 3.9%, Si: 1.4% and MO: 0.4%.
